(19) United States
(12) Patent Application Publication
(10) Pub. No.: US 2015/0047254 A1
(43) Pub. Date: Feb. 19, 2015

(54) ENERGY-SAVING TYPE PLANT CULTIVATION SYSTEM

(71) Applicant: National Taiwan University, Taipei (TW)

(72) Inventors: Joe-Air Jiang, Taipei (TW); Yu-Li Su, Taipei (TW); Kun-Chang Kuo, Taipei (TW); Jen-Cheng Wang, Taipei (TW); Jyh-cherng Shieh, Taipei (TW); Chien-Hao Wang, Taipei (TW); Yu-Kai Huang, Taipei (TW); Chi-Hui Chen, Taipei (TW); Chi-Yang Lee, Taipei (TW)

(21) Appl. No.: 14/459,838

(22) Filed: Aug. 14, 2014

(30) Foreign Application Priority Data
Aug. 14, 2013 (TW) 102129099

(51) Int. Cl. A01G 9/14

(52) U.S. Cl. CPC A01G 9/14
USPC 47/17

(57) ABSTRACT

An energy-saving type plant cultivation system is provided, which includes: a first power source for generating first electric power from solar or wind energy; a plant cultivation device electrically connected to the first power source for receiving the first electric power, and having a plurality of layers of cultivation plates and further having at least a transparent sidewall to facilitate a monitoring staff to observe growth of the plants; a second power source electrically connected to the plant cultivation device so as to supply second electric power to the plant cultivation device; and a power storage unit electrically connected to the first power source, the plant cultivation device and the second power source so as to receive and store the first electric power or the second electric power and supply third electric power to the plant cultivation device if the first electric power or the second electric power is not sufficient.

### BACKGROUND OF THE INVENTION

1. Field of the Invention

The present invention relates to plant cultivation systems, and more particularly, to an energy-saving type plant cultivation system.

2. Description of Related Art

Agricultural production is greatly influenced by environmental conditions, especially climate conditions and soil resources. The environmental conditions affect crop varieties and farming modes in varying degrees. Particularly, the climate conditions have the greatest influences on agricultural productivity, stability and farming. Taiwan has a subtropical climate and global warming in recent years may cause high temperature extremes, dry winters and wet summers to occur, thereby influencing the growth of crops.

In order to effectively improve the agricultural productivity per unit area and reduce the impact of environmental factors on crops, intensive farming systems will be a developing direction of precision agriculture in the future. Plant factories are good examples of precision agriculture, which are adapted to the climate in Taiwan and increase the land use efficiency.

Taiwan Patent No. 1332,819 discloses a three-dimensional plant cultivation tower having a tower structure with a plurality of stack spaces for cultivation of plant seedlings. Plant seedlings are fed through an inlet to the tower and passed through the stack spaces to ripen and then conveyed to an outlet for harvest, thus forming a successive plant production line. By performing a decision-making process without human intervention, control signals are generated by a control unit so as to control a pump device to supplement a certain quantity of cultivation solution at a certain time interval during the growth period, control a light source device to supply light in the case of insufficient light, and control a plurality of vertically conveying devices and horizontally pushing devices to convey plant seedlings from the inlet to the outlet. Therefore, the above-described three-dimensional plant cultivation tower achieves maximum economic benefits by minimizing land and manpower costs.

However, the three-dimensional plant cultivation tower uses a city power station as a main power source. Further, the three-dimensional plant cultivation tower consumes a large amount of electric energy for conveying the plant seedlings in the stack spaces, supplementing the cultivation solution and supplying light in the case of insufficient light.

Therefore, there is a need to provide an energy-saving type plant cultivation system so as to overcome the above-described drawbacks.

### SUMMARY OF THE INVENTION

In view of the above-described drawbacks, the present invention provides an energy-saving type plant cultivation system device that uses a renewable energy source as a main power source.

The energy-saving type plant cultivation system device of the present invention comprises: a first power source for generating first electric power from solar or wind energy; a plant cultivation device electrically connected to the first power source for receiving the first electric power from the first power source, and having a plurality of layers of cultivation plates therein for cultivating plants and further having at least a transparent sidewall to facilitate a monitoring staff to observe growth of the plants inside the plant cultivation device; a second power source electrically connected to the plant cultivation device so as to supply second electric power to the plant cultivation device; and a power storage unit electrically connected to the first power source, the plant cultivation device and the second power source so as to receive and store the first electric power or the second electric power and supply third electric power to the plant cultivation device when the first electric power or the second electric power is not sufficient for the plant cultivation device.

In an embodiment, the first power source is a solar or wind power generation system and the second power source is a city power station.

By using the first power source instead of the second power source as a main power source, the present invention reduces energy consumption. Further, if needed, excess electric power can be fed back to the second power source, i.e., the city power station, so as to be supplied to other loads.

Furthermore, by using the first power source, the second power source and the power storage unit as power sources to supply electric power to the plant cultivation device, the present invention ensures a sufficient power supply for the plant cultivation device.

### BRIEF DESCRIPTION OF DRAWINGS

FIG. 1 is a schematic block diagram of an energy-saving type plant cultivation system of the present invention;

FIG. 2 is a schematic diagram of a plant cultivation device of the present invention;

FIG. 3 is a schematic diagram showing sensing of the plant cultivation device through wireless sensing nodes according to the present invention;

FIG. 4 is a schematic flow diagram showing the process of first electric power according to the present invention; and

FIG. 5 is a schematic flow diagram showing the process of second electric power according to the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

It should be noted that all the drawings are not intended to limit the present invention. Various modifications and variations can be made without departing from the spirit of the present invention. Further, terms such as “on”, “a” etc. are merely for illustrative purposes and should not be construed to limit the scope of the present invention.

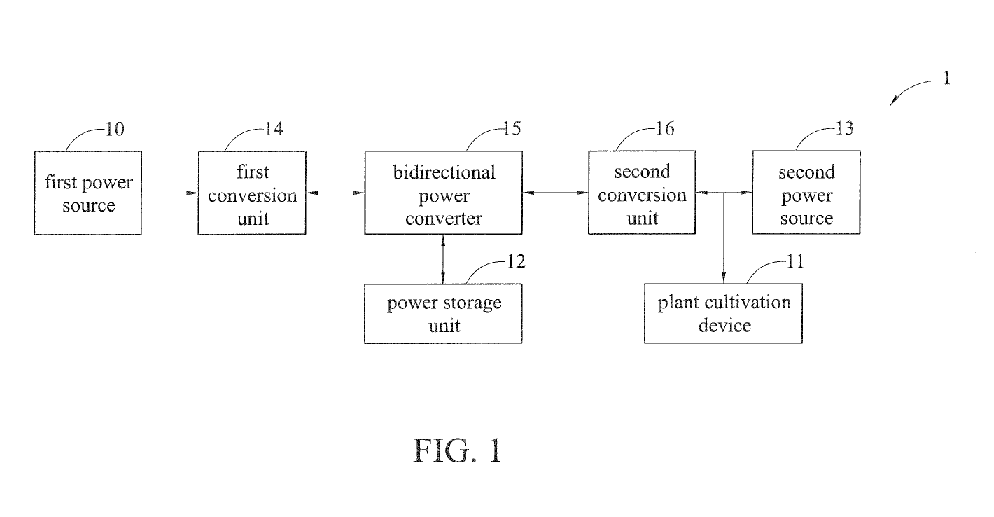

FIG. 1 is a schematic block diagram of an energy-saving type plant cultivation system 1 of the present invention. The energy-saving type plant cultivation system 1 has a first power source 10, a plant cultivation device 11, a power storage unit 12 and a second power source 13.

The first power source 10 is used to output first electric power. The plant cultivation device 11 is electrically connected to the first power source 10 for receiving the first electric power. The power storage unit 12 is electrically connected to the first power source 10 and the plant cultivation device 11 for receiving and storing the first electric power.

The first power source 10 is a renewable power source such as a solar or wind power generation system that generates the first electric power. The energy-saving type plant cultivation system 1 of the present invention is characterized in that the first power source 10 is used as a main power source. The first electric power from the first power source 10 is first stored in the power storage unit 12 until the power storage unit 12 is full, and then the remaining first electric power is transmitted to the plant cultivation device 11.

The first electric power from the first power source 10 is AC power and the electric power stored in the power storage unit 12 is DC power. Therefore, a first conversion unit 14 is provided between the first power source 10 and the power storage unit 12 for converting the first electric power from AC power to DC power. Further, a bidirectional power converter 15 is provided between the first conversion unit 14 and the power storage unit 12 so as to step down voltage for the DC power converted from the first electric power. After step down of the voltage, the DC power is stored in the power storage unit 12. As such, when the first power source 10 or the second power source 13 cannot supply electric power to the plant cultivation device 11, the power storage unit 12 can supply electric power to the plant cultivation device 11.

The second power source 13 is electrically connected to the plant cultivation device 11 for supplying second electric power to the plant cultivation device 11. If the amount of the second electric power exceeds the amount required for operation of the plant cultivation system 11, the excess second electric power can be transmitted to and stored in the power storage unit 12.

In the present embodiment, the second power source 13 is a city power station. The second electric power from the second power source 13 is AC power and the electric power stored in the power storage unit 12 is DC power. Therefore, a second conversion unit 16 is provided between the second power source 13 and the power storage unit 12 for converting the second electric power from AC power to DC power. Further, the bidirectional power converter 15 is used to step down voltage for the DC power converted from the second electric power. After step down of the voltage, the DC power is stored in the power storage unit 12.

In the present invention, the first electric power from the first power source 10 is completely converted by the first conversion unit 14 from AC power to DC power and stepped down by the bidirectional power converter 15 and then stored in the power storage unit 12. After the power storage unit 12 is full, the remaining DC power will be transmitted to the plant cultivation device 11. However, since the plant cultivation device 11 needs AC power for operation, the DC power from the bidirectional power converter 15 are first converted by the second conversion unit 16 to AC power and then supplied to the plant cultivation device 11. Thereafter, if there is any excess AC power left, it can be fed back to the second power source 13 so as to be supplied to other loads.

The energy-saving type plant cultivation system 1 of the present invention uses the first power source 10, for example, a solar or wind power generation system, as a main power source, and uses the second power source 10, for example, a city power station, as a secondary power source so as to reduce energy consumption. Further, the first electric power not only can be stored in the power storage unit 12 or supplied to the plant cultivation device 11, but also can be fed back to the second power source 13 so as to be completely utilized.

Furthermore, if the first electric power from the first power source 10 is not sufficient for operation of the plant cultivation device 11 or no electric power is provided by the first power source 10, the second power source 13 can be used to supply the second electric power to the plant cultivation device 11 and the power storage unit 12 can serve as an auxiliary power source. On the other hand, if the second electric power from the second power source 13 is not sufficient for operation of the plant cultivation device 11 or no electric power is provided by the second power source 13, the first power source 10 can be used to supply the first electric power to the plant cultivation device 11 and the power storage unit 12 can serve as an auxiliary power source. If neither the first power source 10 nor the second power source 13 provides electric power, and neither the first power nor the second electric power is sufficient for operation of the plant cultivation device, the power storage unit 12 can supply third electric power to the plant cultivation device 11.

The third electric power is stepped up by the bidirectional power converter 15 first and then transmitted to the second conversion unit 16 so as to be converted to AC power, and the AC power converted from the third electric power is supplied to the plant cultivation device 11.

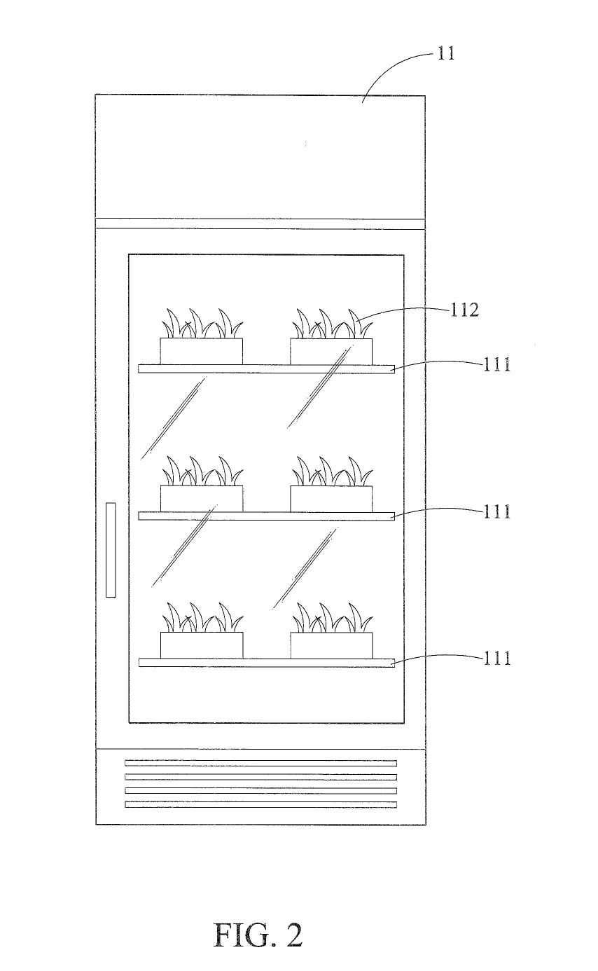

FIG. 2 is a schematic diagram of the plant cultivation device 11 of the present invention. In an embodiment, a refrigerator usually used in a convenience store is used as the plant cultivation device 11. The plant cultivation device 11 has a plurality of layers of cultivation plates 111 therein for cultivating plants 112 such as flowers and vegetables. Compared with the conventional plant factories, the refrigerator has a smaller size and hence needs less time to adjust the temperature inside the plant cultivation device 11 and facilitates a monitoring staff to control the change of various environment factors such as temperature and humidity inside the plant cultivation device 11.

Further, the refrigerator has a transparent sidewall so as to facilitate the monitoring staff to observe growth of the plants 112 inside the plant cultivation device 11. The transparent side wall can be a glass door.

It should be noted than the present invention is not limited to the refrigerator. In other embodiments, the plant cultivation device 11 can be any other device having a closed space.

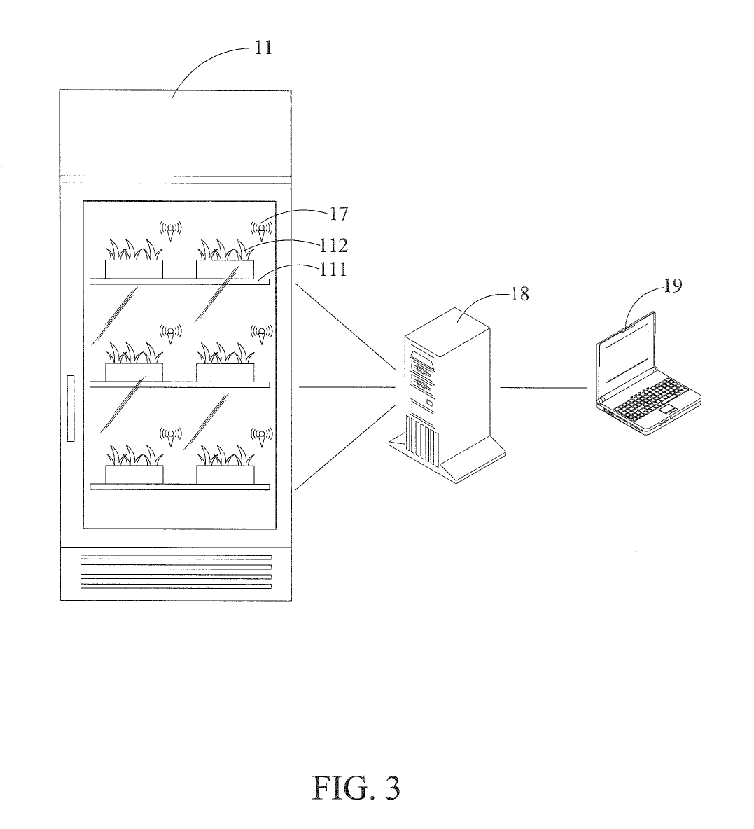

FIG. 3 is a schematic diagram showing sensing of the plant cultivation device 11 through a plurality of wireless sensing nodes 17. The wireless sensing nodes 17 are disposed in the plant cultivation device 11 for monitoring the growth environment of the plants 112 inside the plant cultivation device 11.

Referring to FIG. 3, the wireless sensing nodes 17 are distributed in the plant cultivation device 11 for sensing the change of the environmental factors such as air condition, light, water, nutrients and gases inside the plant cultivation device 11 and sending sensing results through a gateway device 18 to a remote monitor system 19. As such, the monitoring staff not only can observe the growth of the plants 112 through the glass door of the plant cultivation device 11, but also can obtain the sensing results from the wireless sensing nodes 17 through the monitor system 19. If necessary, the monitoring staff can operate the monitor system 19 to control light, air, water or nutrients of certain regions, the individual cultivation plates 111, or the entire plant cultivation device 11. Since such controlling technologies are well known in the art, detailed description thereof is omitted herein.

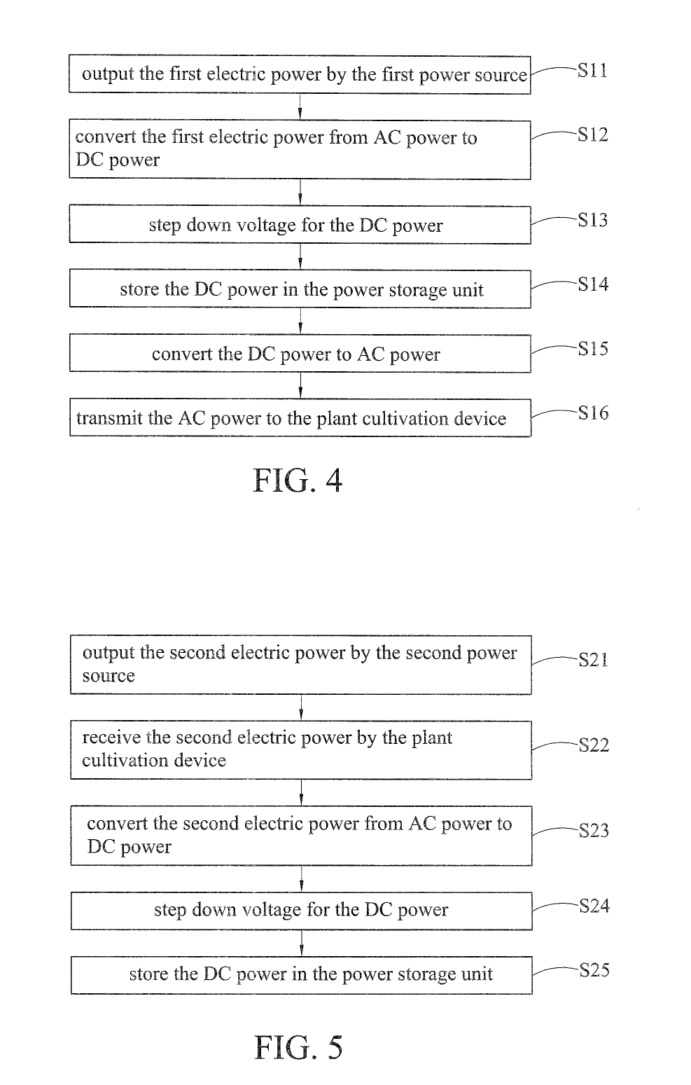

FIG. 4 is a schematic flow diagram showing the process of the first electric power according to the present invention. Referring to FIG. 4, first, at step S11, the first power source outputs the first electric power. Then, at step S12, the first electric power is converted from AC power to DC power. Thereafter, at step S13, the DC power is stepped down. Subsequently, at step S14, the DC power is stored in the power storage unit. Then, at step S15, the DC power is converted to AC power. Thereafter, at step S16, the AC power is transmitted to the plant cultivation device.

FIG. 5 is a schematic flow diagram showing the process of the second electric power. Referring to FIG. 5, first, at step S21, the second power source outputs the second electric power. Then, at step S22, the plant cultivation device receives the second electric power for operation. Thereafter, at step S23, the second electric power is converted from AC power to DC power. Subsequently, at step S24, the DC power is stepped down. Thereafter, at step S25, the DC power is stored in the power storage unit.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An energy-saving type plant cultivation system, comprising:
a first power source for generating first electric power from solar or wind energy;
a plant cultivation device electrically connected to the first power source for receiving the first electric power from the first power source, and having a plurality of layers of cultivation plates therein for cultivating plants and further having at least a transparent sidewall to facilitate a monitoring staff to observe growth of the plants inside the plant cultivation device;
a second power source electrically connected to the plant cultivation device so as to supply second electric power to the plant cultivation device; and
a power storage unit electrically connected to the first power source, the plant cultivation device and the second power source so as to receive and store the first electric power or the second electric power and supply third electric power to the plant cultivation device when the first electric power or the second electric power is not sufficient for the plant cultivation device.

2. The system of claim 1, wherein the plant cultivation device is a refrigerator and the transparent sidewall is a glass door.

3. The system of claim 1, wherein the first power source is a solar or wind power generation system.

4. The system of claim 1, wherein the first electric power and the second electric power are AC power and the third electric power is DC power.

5. The system of claim 4, further comprising a first conversion unit electrically connected to the first power source and the power storage unit for converting the first electric power to DC power so as to store the DC power converted from the first electric power in the power storage unit and transmit the DC power converted from the first electric power to the plant cultivation device.

6. The system of claim 5, further comprising a second conversion unit electrically connected to the power storage unit and the plant cultivation device for converting the second electric power to DC power and storing the DC power converted from the second electric power in the power storage unit or converting the third electric power to AC power and transmitting the AC power converted from the third electric power to the plant cultivation device.

7. The system of claim 6, further comprising a bidirectional power converter for stepping down voltage for the DC power converted from the first electric power or the second electric power or stepping up voltage for the third electric power.

8. The system of claim 1, further comprising a plurality of wireless sensing nodes distributed in the plant cultivation device for monitoring a plant growth environment inside the plant cultivation device and transmitting a sensing result through a gateway device to a remote monitor device.

9. The system of claim 8, wherein the plant growth environment comprises at least one of air condition, light, water, nutrients and gases.

10. The system of claim 1, wherein the second power source is a city power station.

11. The system of claim 1, wherein the first electric power or the second electric power not sufficient for the plant cultivation device includes that the first or second electric power is not supplied by the first or second power source or the first or second electric power is not adequate for operation of the plant cultivation device.
